(19) United States
(12) Patent Application Publication
(10) Pub. No.: US 2020/0025580 A1
(43) Pub. Date: Jan. 23, 2020

(54) INFORMATION PROCESSING APPARATUS AND INFORMATION PROCESSING METHOD

(71) Applicant: TOYOTA JIDOSHA KABUSHIKI KAISHA, Toyota-shi (JP)

(72) Inventors: Masayuki MATSUDA, Seto-shi (JP); Kazuhiko NAKANISHI, Kariya-shi (JP); Yuko MIZUNO, Nagoya-shi (JP); Satoshi SHIMADA, Chiryu-shi (JP); Takuya MAEKAWA, Nisshin-shi (JP); Yorichika ISHIYAMA, Nagoya-shi (JP)

(73) Assignee: TOYOTA JIDOSHA KABUSHIKI KAISHA, Toyota-shi (JP)

(21) Appl. No.: 16/504,384

(22) Filed: Jul. 8, 2019

(30) Foreign Application Priority Data
Jul. 18, 2018 (JP) 2018-135268

(51) Int. Cl. G01C 21/34; G01C 21/36

(52) U.S. Cl. CPC G01C 21/3438; G01C 21/3605; G01C 21/3453

(57) ABSTRACT

An information processing apparatus comprising a processor configured to transmit, through a communicator, a notification that a carpool passenger is recruited, according to a request from a planner who planned ride-sharing, and acquire information on a carpool demander who demands carpooling for the ride-sharing in response to the notification, the carpool demander satisfying a condition related to a distance from a reference position.

### CROSS REFERENCE TO THE RELATED APPLICATION

This application claims the benefit of Japanese Patent Application No. 2018-135268, filed on Jul. 18, 2018, which is hereby incorporated by reference herein in its entirety.

### BACKGROUND

### Technical Field

The present disclosure relates to an information processing apparatus and an information processing method.

### Description of the Related Art

In recent years, a mode of transportation has spread in which multiple users carpool (ride-share) in the same vehicle. Ride-sharing can reduce the amount of traffic and thus shorten travel time, reduce CO₂ emissions, and reduce travel costs.

Actual ride-sharing needs matching between multiple users demanding ride-sharing. Various methods are proposed as such a matching method (for example, Patent document 1). In the method described in Patent document 1, a user to be a driver registers an itinerary and an application guideline related to the itinerary to a server. Subsequently, a user who is a carpool demander receives a list of itineraries from the server and displays it on his/her mobile terminal. If there is any itinerary of interest, he/she selects it, and displays an application guideline related to the selected itinerary. When a carpool demander viewing the application guideline wants to reserve ride-sharing for this itinerary, he/she pushes the application button displayed on the mobile terminal. Pushing the application button notifies the server of this fact. Afterwards, the server notifies the fact that an application for a reservation has been made to the mobile terminal of the user to be the driver. When the driver receiving the notification pushes the approval button displayed on the mobile terminal, this fact is notified to the server, and the user who has applied from the reservation is registered as a carpool passenger to the database; thus, matching is succeeded.

### CITATION LIST

### Patent Document

[Patent document 1]

### Japanese Patent Laid-Open No. 2016-194854

An object of the present disclosure is to provide an information processing apparatus and an information processing method that enable flexible matching between multiple users demanding ride-sharing.

### SUMMARY

The first aspect of the present disclosure is an information processing apparatus including a processor configured to:

transmit, through a communicator, a notification that a carpool passenger is recruited, according to a request from a planner who planned ride-sharing, and

acquire information on a carpool demander who demands carpooling for the ride-sharing in response to the notification, the carpool demander satisfying a condition related to a distance from a reference position.

The second aspect of the present disclosure is an information processing method comprising:

transmitting, through a communicator, a notification that a carpool passenger is recruited, according to a request from a planner who planned ride-sharing; and

acquiring information on a carpool demander who demands carpooling for the ride-sharing in response to the notification, the carpool demander satisfying a condition related to a distance from a reference position.

The third aspect of the present disclosure is a non-transitory computer-readable medium recorded with a program causing a computer to execute:

transmitting, through a communicator, a notification that a carpool passenger is recruited, according to a request from a planner who planned ride-sharing; and

acquiring information on a carpool demander who demands carpooling for the ride-sharing in response to the notification, the carpool demander satisfying a condition related to a distance from a reference position.

The present disclosure can provide an information processing apparatus and an information processing method that enable flexible matching between multiple users demanding ride-sharing.

### BRIEF DESCRIPTION OF THE DRAWINGS

FIG. 1 is a schematic configuration diagram illustrating a matching system according to the first embodiment;

FIG. 2 is a system configuration diagram illustrating a user terminal 10 according to the first embodiment;

FIG. 3 is a system configuration diagram illustrating a user terminal 20 according to the first embodiment;

FIG. 4 is a system configuration diagram illustrating a server 30 according to the first embodiment;

FIG. 5 is a diagram illustrating information stored in a user information database;

FIG. 6 is a diagram illustrating information stored in a ride-sharing management database;

FIG. 7 is a flow chart of recruitment target user extraction processing according to the first embodiment;

FIG. 8 is a flow chart of recruitment processing according to the first embodiment;

FIG. 9 is a flow chart of processing according to the first modification of the first embodiment;

FIG. 10 is a diagram illustrating ride-sharing management information according to the first modification;

FIG. 11 is a diagram illustrating user information according to the first modification;

FIG. 12 is a flow chart of processing according to the second modification of the first embodiment;

FIG. 13 is a system configuration diagram illustrating a server 40 according to the second embodiment;

FIG. 14 is a flow chart of matching processing according to the second embodiment;

FIG. 15 is a flow chart of processing according to the first modification of the second embodiment;

FIG. 16 is a flow chart of processing according to the second modification of the second embodiment;

FIG. 17 is a schematic configuration diagram illustrating a matching system according to the third embodiment;

FIG. 18 is a system configuration diagram illustrating a user terminal 50 according to the third embodiment;

FIG. 19 is a diagram illustrating information stored in a user information database;

FIG. 20 is a system configuration diagram illustrating a user terminal 60 according to the third embodiment;

FIG. 21 is a flow chart of matching processing according to the third embodiment;

FIG. 22 is a flow chart of processing according to the first modification of the third embodiment; and

FIG. 23 is a flow chart of processing according to the second modification of the third embodiment.

### DESCRIPTION OF THE EMBODIMENTS

To match multiple users to ride-share in the same vehicle, users to ride-share are required to pre-register their departure points, destinations, travel paths, departure times, and other information to a server. The users demanding ride-sharing then access to the server to check these pieces of information. If there is ride-sharing the users demand, they reserve the ride-sharing at the server. Upon reception of the reservation from each user demanding ride-sharing, the server determines users to be allowed to ride-share, according to the attribute and the like of each user.

Thus, to match multiple users to ride-share in the same vehicle, preparation and a certain amount of time are needed. Accordingly, even if the occasion of providing ride-sharing suddenly arises, it is difficult to achieve flexible matching between users on that occasion, considering the time for preparation or recruitment.

Considering this fact, this embodiment provides an information processing apparatus that achieves, even if the occasion of providing ride-sharing suddenly arises, flexible matching between users on that occasion.

An information processing apparatus according to a first aspect of the present disclosure may transmit, through a communicator, a notification that a carpool passenger is recruited, according to a request from a planner who planned ride-sharing, and acquire information on a carpool demander who demands carpooling for the ride-sharing in response to the notification, the carpool demander satisfying a condition related to a distance from a reference position.

If the occasion of providing ride-sharing suddenly arises, the notification that carpool passengers is recruited is transmitted according to a request from a user who tries to provide ride-sharing, that is, a planner; thus, carpool passengers can be recruited immediately as needed.

If the notification that carpool passengers is recruited is transmitted in the form of a push notification, the notification is immediately viewed by the users. For this reason, carpool passengers can be immediately recruited without missing the sudden occasion of ride-sharing, for example, the time when a planner is already driving a vehicle to be used for ride-sharing, or when there is no much time before execution of the ride-sharing.

Further, information on carpool demanders satisfying a condition related to a distance from a reference position among carpool demanders demanding carpooling in response to the notification that carpool passengers is recruited is acquired.

Here, a reference position is a position serving as a reference of the condition related to a distance for filtering carpool demanders; examples include the departure point of ride-sharing designated by a planner, the position of a vehicle used for ride-sharing, and the position of an apparatus such as the terminal of the planner. The condition related to a distance from a reference position is, for example, the condition that the apparatus of the carpool demander is present within a predetermined distance from a reference position. The condition related to a distance from a reference position is not limited to that defined as a specific distance from the reference position, and may physically limit the area where a notification that triggers a response can be received, like the communicable area of communication media used to issue the notification that carpool passengers is recruited. In addition, the condition related to a distance from a reference position may be defined by a required time from a reference position. In addition, the condition related to a distance from a reference position may be defined by a geographic region like an administrative area.

Carpool demander filtering based on whether or not such a condition related to a distance from a reference position is satisfied may be performed in any step of matching. In other words, for potential carpool demanders yet to receive a notification, information for determining whether or not the condition is satisfied may be acquired in advance and a notification of recruitment may be transmitted to potential carpool demanders satisfying the condition. Further, for carpool demanders who have responded to the notification of recruitment, information for determining whether or not the condition is satisfied may be acquired and whether or not it is satisfied may be then determined.

If matching between carpool passengers is performed based on information on carpool demanders satisfying the condition related to a distance from a reference position, even in the case of ride-sharing with the departure time approaching, flexible matching targeted at people who can get to the reference position in short time and are highly likely to demand ride-sharing is possible.

As described above, in this embodiment, in quick response to an occasion of providing ride-sharing, flexible matching between multiple users to ride-share can be achieved.

Concrete embodiments of the present disclosure will now be described with reference to the accompanying drawings. The hardware configurations, module configurations, functional configurations, and the like described in the embodiments are not intended to limit the technical scope of the present disclosure thereto unless otherwise noted.

### First Embodiment

### (Overview of System)

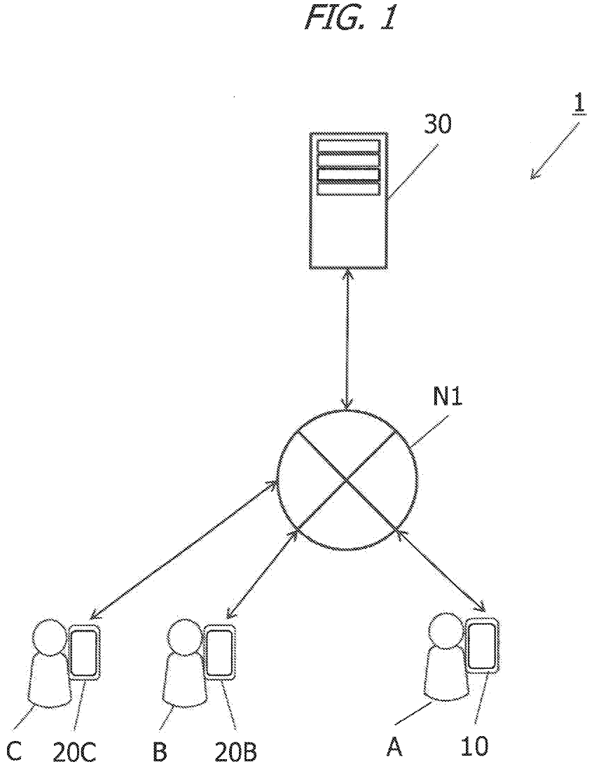

FIG. 1 is a diagram illustrating a schematic configuration of a matching system 1 (hereinafter referred to as “system 1”) according to this embodiment. In the example illustrated in FIG. 1, the system 1 includes a user terminal 10 owned by a user A, user terminals 20B and 20C owned by users B and C, and a server 30. In the description below, when the user terminals 20B and 20C are collectively indicated, B and C for distinguishing between users are omitted. The user terminal 10, the user terminals 20, and the server 30 are connected to each other via a network N1. Although FIG. 1 illustrates only two people B and C as users who own the user terminals 20, this is not necessarily the number of users who own a user terminal 20.

The network N1 may be, for example, a wide area network (WAN) which is a worldwide public communication network, such as the Internet, or other communication networks. In addition, the network may include a telephone communication network such as that for cellular phones, or a wireless communication network such as Wi-Fi (registered trademark).

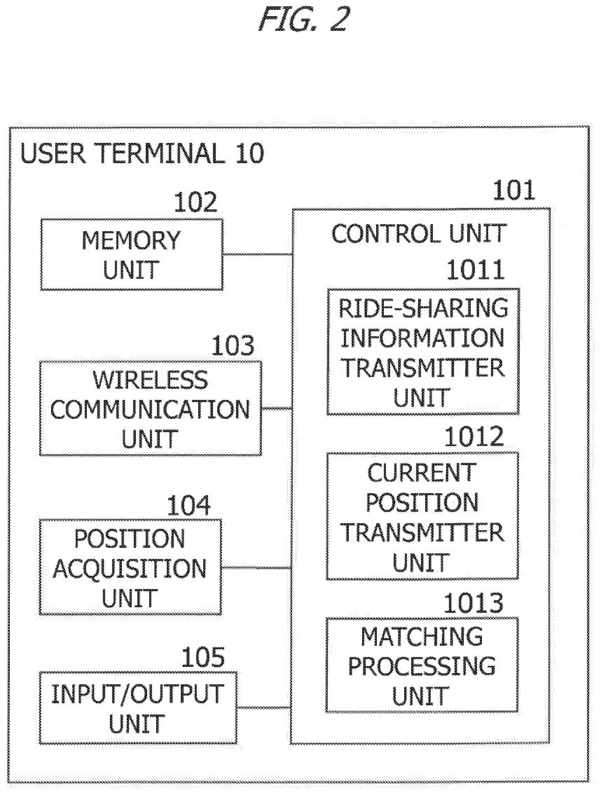

The configuration of the user terminal 10 will now be described. FIG. 2 is a diagram illustrating the system configuration of the user terminal 10.

The user terminal 10 is a terminal owned by the user A who plans ride-sharing. Here, the user A who plans ride-sharing is a user driving a vehicle used for ride-sharing. However, the user A who plans ride-sharing may be a user to carpool a vehicle used for ride-sharing.

The user terminal 10 is, for example, a smartphone, a cellular phone, a tablet computer, a personal information terminal, a laptop computer, a wearable computer (such as a smartwatch), or other compact computers. The user terminal 10 includes a control unit 101, a memory unit 102, a wireless communication unit 103, a position acquisition unit 104, and an input/output unit 105.

The control unit 101 is an arithmetic processing apparatus that is responsible for the control by the user terminal 10. The control unit 101 can be implemented using an arithmetic processing apparatus such as a central processing unit (CPU).

The control unit 101 is composed of function modules of a ride-sharing information transmitter unit 1011, a current position transmitter unit 1012, and a matching processing unit 1013. Each function module may be implemented by executing a program stored in the memory unit 102, which will be described later, through a CPU.

The ride-sharing information transmitter unit 1011 transmits information on ride-sharing planned by the user A to the server 30. Ride-sharing information includes at least a departure point, a destination, a scheduled departure date and time, and a number of people to be recruited.

The current position transmitter unit 1012 transmits the current position of the user terminal 10 acquired by the position acquisition unit 104 to the server 30.

The matching processing unit 1013 processes the matching results received from the server 30 and presents them to the user A through the input/output unit 105. It encourages the user A to give an input and transmits information input through the input/output unit 105 to the server 30 as needed.

The memory unit 102 includes a main memory apparatus and an auxiliary storage apparatus. The main memory apparatus is a memory in which programs to be executed by the control unit 101 and data used for the programs are expanded. The auxiliary storage apparatus is an apparatus storing programs to be executed by the control unit 101 and data used for the programs. The auxiliary storage apparatus may store a package of the programs to be executed by the control unit 101 as applications. An operating system for executing these applications may also be stored. The programs stored in the auxiliary storage apparatus are loaded to the main memory apparatus and executed by the control unit 101, so that the following processing is performed.

The main memory apparatus may include a random access memory (RAM) or read only memory (ROM). In addition, the auxiliary storage apparatus may include an erasable programmable rom (EPROM) or hard disk drive (HDD). The auxiliary storage apparatus may further include a removable medium, that is, a portable recording medium. This is a disc recording medium, such as a removable medium or digital versatile disc (DVD).

The wireless communication unit 103 is a wireless communication interface for connecting the user terminal 10 to the network N1. The wireless communication unit 103 provides access to the network N1 through, for example, wireless LAN or 3G, LTE or other mobile communication services.

The position acquisition unit 104 acquires the current position of the user terminal 10. Here, it is composed of, for example, a GPS unit that detects the current position of the user terminal 10 according to the radio waves from a global positioning system (GPS) satellite. The position acquisition unit 104 may detect the current position of the user terminal 10 according to the incoming time of the radio waves transmitted from the multiple wireless base stations, which wirelessly communicate with the user terminal 10, to the user terminal 10. In the case where the user terminal 10 communicates through a wireless LAN, the position acquisition unit 104 may detect the current position of the user terminal 10, according to the intensity of the radio waves that the user terminal 10 receives from multiple access points.

The input/output unit 105 presents information to the user in response to input operation made by the user. In this embodiment, it includes a touch screen display, microphone, and speaker. In particular, it is composed of a liquid crystal display and its controller, a touch screen and its controller, a microphone and its controller, and a speaker and its controller.

Note that the configuration illustrated in FIG. 2 is merely illustrative, and all or part of the functions illustrated in the drawing may be executed using a specifically designed circuit. In addition, programs may be stored or executed using a main memory apparatus and an auxiliary storage apparatus, which are other than those illustrated in the drawing, in combination.

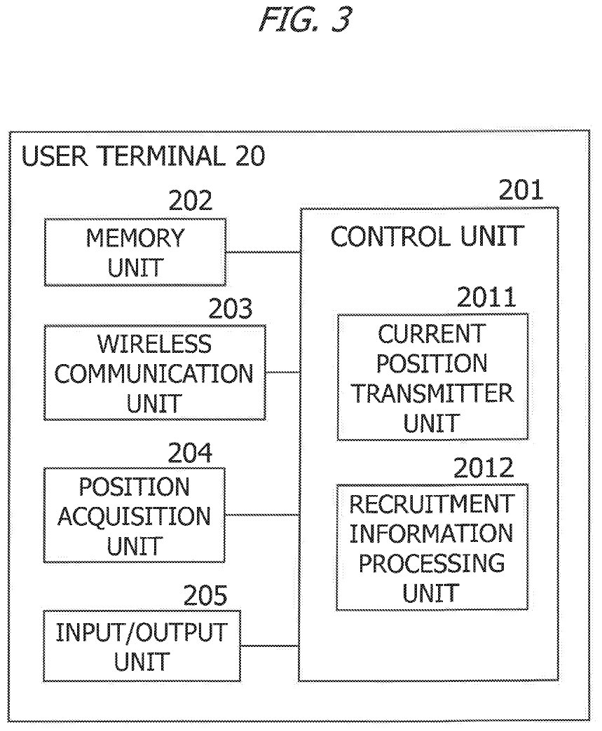

The configuration of the user terminal 20 will now be described. FIG. 3 is a diagram illustrating the system configuration of the user terminal 20.

The user terminal 20 is owned by, for example, users B and C who are the users of the system 1 and are potential carpool passengers of ride-sharing.

The user terminal 20 is, for example, a smartphone, a cellular phone, a tablet computer, a personal information terminal, a laptop computer, a wearable computer (such as a smartwatch), or other compact computers. The user terminal 20 includes a control unit 201, a memory unit 202, a wireless communication unit 203, a position acquisition unit 204, and an input/output unit 205.

The configurations of the memory unit 202, the wireless communication unit 203, the position acquisition unit 204, and the input/output unit 205 are the same as those of the memory unit 102, the wireless communication unit 103, the position acquisition unit 104, and the input/output unit 105, respectively, and their detailed description will therefore be omitted.

The control unit 201 is an arithmetic processing apparatus that is responsible for the control by the user terminal 20. The control unit 201 can be implemented using an arithmetic processing apparatus such as a CPU.

The control unit 201 is composed of function modules of a current position transmitter unit 2011 and a recruitment information processing unit 2012. Each function module may be implemented by executing the program stored in the memory unit 202 through a CPU.

The current position transmitter unit 2011 transmits the current position of the user terminal 20 acquired by the position acquisition unit 204 to the server 30.

The recruitment information processing unit 2012 receives information about the fact that those demanding ride-sharing received from the server 30 will be recruited (the notification that carpool passengers will be recruited) through the wireless communication unit 203, and presents it to the users B and C through the input/output unit 205. It encourages the users B and C to give an input and transmits information input through the input/output unit 205 to the server 30 as needed.

The configuration of the server 30 will now be explained.

The server 30 is composed of a general-purpose computer. In particular, the server 30 is a computer including a CPU, a GPU, or other processors, a RAM, a ROM, or other main memory apparatuses, an EPROM, a hard disc drive, a removable medium, or other auxiliary storage apparatuses. Note that the removable medium may be, for example, a USB memory, or a CD, a DVD, or other disc recording media. The auxiliary storage apparatus stores an operating system, various programs, various tables, and the like, and loads the programs stored therein to a work area in the main memory apparatus and executes it. Through the execution of the programs, each component or the like is controlled, so that various functions meeting predetermined purposes described below can be implemented. However, part or all of the functions may be implemented using a hardware circuit, such as an ASIC or FPGA. Note that the server 30 may be composed of a single computer or multiple computers in cooperation.

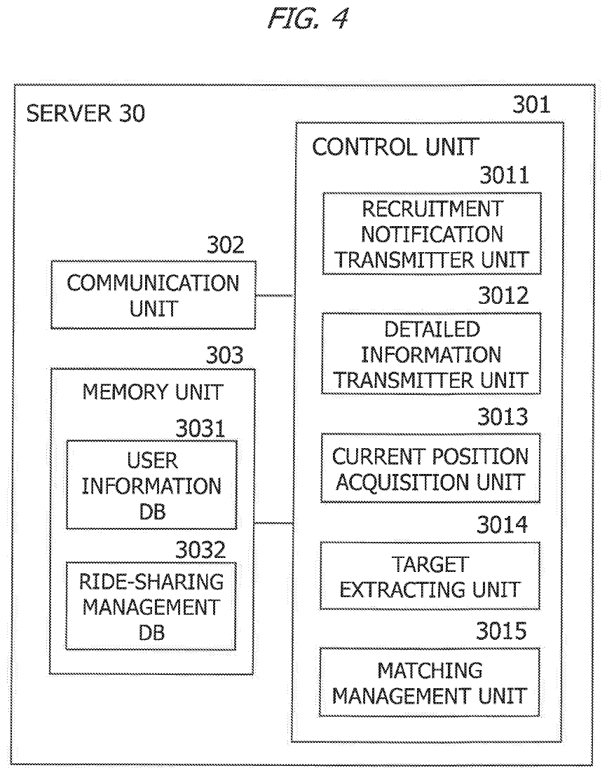

FIG. 4 is a diagram illustrating the system configuration of the server 30. The server 30 includes a control unit 301, a communication unit 302, and a memory unit 303.

The communication unit 302 is a communication interface for connecting the server 30 to the network N1. The communication unit 302 includes, for example, a network interface board and a wireless communication circuit for wireless communication. A notification unit is capable of communication supporting various communication methods including push notification which will be described later.

The memory unit 303 includes a main memory apparatus and an auxiliary storage apparatus. The main memory apparatus is a memory in which programs to be executed by the control unit 301 and data used for the program are expanded. The auxiliary storage apparatus is an apparatus storing programs to be executed by the control unit 301 and data used for the programs. The main memory apparatus and the auxiliary storage apparatus are the same as those in the memory unit 102, and their detailed description will therefore be omitted.

Further, the memory unit 303 stores a user information database 3031 and a ride-sharing management database 3032.

The user information database 3031 is a database storing information on users registered as users to a ride-sharing support system including a matching system according to this embodiment.

The ride-sharing management database 3032 is a database storing information for managing planned ride-sharing.

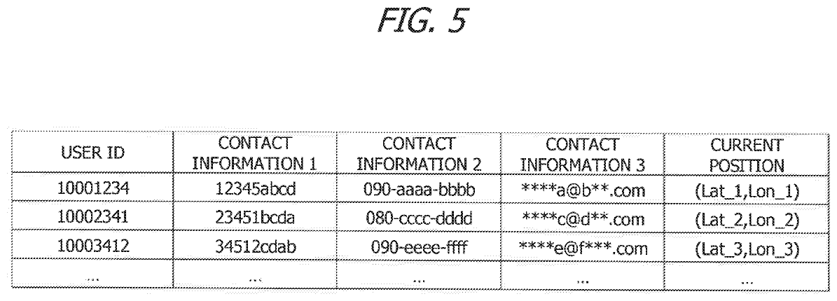

A table configuration of user information stored in the user information database 3031 will now be described with reference to FIG. 5.

The user information table includes a user ID field, a contact information 1 field, a contact information 2 field, a contact information 3 field, and a current position field.

In the user ID field, user IDs which are identification information for identifying users are input.

The contact information 1 field stores terminal IDs serving as identification information for identifying user terminals installed with an application related to ride-sharing. The terminal IDs stored in the contact information 1 field serve as destinations of push notification. Examples of such terminal IDs include, but are not limited to, registration IDs for Google (registered trademark) Cloud Messaging (GCM) and Firebase (registered trademark) Cloud Messaging (FCM), and device tokens for APNs (Apple (registered trademark) Push Notification service).

The contact information 2 field stores telephone numbers as user's contact information 1.

The contact information 3 field stores e-mail addresses as user's contact information 2.

The contact information is not limited to these, and may store identification information for identifying the user terminal for communication with the user terminal owned by the user, according to the communication method. For example, accounts of a messenger application can be stored as contact information.

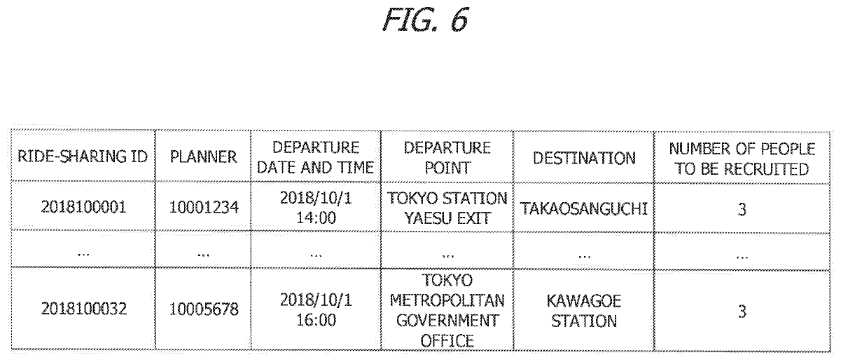

A table configuration of ride-sharing management information stored in the ride-sharing management database 3032 will now be described with reference to FIG. 6.

The ride-sharing management information table includes a ride-sharing ID field, a planner field, a departure date and time field, a departure point field, a destination field, and a number of people to be recruited field.

The ride-sharing ID field stores ride-sharing IDs serving as identification information assigned for identification of ride-sharing to be targets of matching in the system 1.

The planner field stores identification information for identifying users who planned ride-sharing. Here, the planner field stores the user IDs of planners. The departure date and time field stores the departure date and time of each ride-sharing. In the example illustrated in FIG. 6, Oct. 1, 2018 14:00 and Oct. 1, 2018 16:00 are stored.

The departure point field stores the departure point of each ride-sharing. In FIG. 6, Tokyo Station Yaesu Exit and Tokyo Metropolitan Government Office are stored. The destination field stores the destination of each ride-sharing. In the example illustrated in FIG. 6, Takaosanguchi and Kawagoe Station are stored.

The number of people to be recruited field stores the number of carpool passengers to be recruited for each ride-sharing. In the example illustrated in FIG. 6, 3 is stored for each.

The control unit 301 is an arithmetic processing apparatus that is responsible for the control by the server 30. The control unit 301 can be implemented using an arithmetic processing apparatus such as a CPU.

The control unit 301 includes function modules of a recruitment notification transmitter unit 3011, a detailed information transmitter unit 3012, a current position acquisition unit 3013, a target extracting unit 3014, and a matching management unit 3015. Each function module may be implemented by executing the program stored in the auxiliary storage apparatus through a CPU.

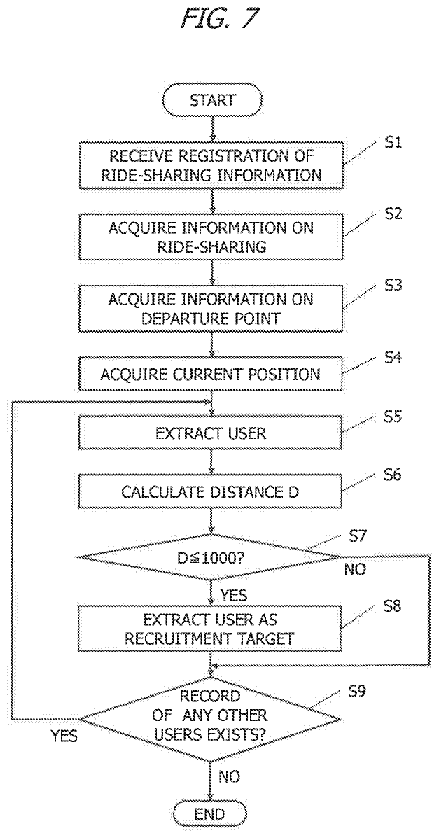

(Recruitment Target User Extraction Processing) The details of recruitment target user extraction processing performed by the control unit 301 of the server 30 will now be described with reference to the flow chart of FIG. 7.

First, in Step S1, registration of ride-sharing information is received from the user A who planned ride-sharing. Here, the user A starts up a ride-sharing application on the user terminal 10, and enters a departure point, a destination, a scheduled departure date and time, a number of people to be recruited, and the like through the input/output unit 105. The ride-sharing information transmitter unit 1011 of the user terminal 10 transmits the received departure point, destination, scheduled departure date and time, number of people to be recruited, and other ride-sharing information to the server 30 through the wireless communication unit 103. The server 30 assigns a ride-sharing ID to the ride-sharing information transmitted from the user terminal 10 and stores it in the ride-sharing management database 3032. When the user A registers ride-sharing information, the server 30 executes the following recruitment target extraction processing and recruitment processing immediately or in response to a request from the user operating a button displayed on the input/output unit 105. Matching processing involving recruitment target extraction processing and recruitment processing is a sequence of information processing methods consecutively executed.

In subsequent Step S2, the target extracting unit 3014 acquires information on ride-sharing, which is a matching target, from the ride-sharing management database 3032. Ride-sharing identified by the ride-sharing ID 2018100032 registered by the user A is acquired as a recruitment target.

In Step S3, the target extracting unit 3014 acquires information stored in the departure point field, from the ride-sharing management information table stored in the ride-sharing management database 3032. For the ride-sharing ID 2018100032, “Tokyo Metropolitan Government Office” is stored in the departure point field. The server 30 has a table for converting the position on the map into a latitude and longitude, and information on the departure point is expressed by the latitude and longitude based on the table. The latitude of Tokyo Metropolitan Government Office is 35 degrees 41 minutes 23.561 seconds, and the longitude is 139 degrees 41 minutes 27.662 seconds.

In Step S4, the current position acquisition unit 3013 acquires the current position from the user terminal 20. Subsequently, information in the current position field of the user information table stored in the user information database 3031 is updated based on the acquired current position.

In Step S5, the target extracting unit 3014 extracts one user from the user information table. At this time, the user A who planned ride-sharing, which is a recruitment target, is excluded from extraction targets. First, the user with the user ID 10001234 is extracted from the table illustrated in FIG. 5. Here, when ride-sharing is planned, all the users stored in the user information table are users who demand to be recruitment targets, that is, notification demanders. The current position of the user with the user ID 10001234 is (Lat_0, Lon_1).

In Step S6, the target extracting unit 3014 calculates the distance D between the user's current position stored in the current position field of the user information table, and the departure point stored in the departure point field of the ride-sharing management information table. In the example described above, the distance D between the point with the latitude of 35 degrees 41 minutes and 23.561 seconds and the longitude of 139 degrees 41 minutes and 27.662 seconds, and the position of the latitude Lat_0 and the longitude Lon_1 is calculated.

In Step S7, the target extracting unit 3014 determines whether or not D≤1000 (m). Although the distance D is compared with the value of 1000 (m) here, this value may be set as appropriate considering the time to the departure time of the ride-sharing, for example. Here, the reference position is a departure point, and the condition related to the distance from the reference position is that the distance D between the departure point and the current position of the user terminal 20 is 1000 (m) or less.

If it is determined that D≤1000 (m) in Step S7, the user is extracted as a recruitment target in Step S8, and the process proceeds to Step S9. At the time, a flag indicating that the user is a recruitment target is provided in the user information table, and this flag is turned ON.

If it is determined that D>1000 (m) in Step S7, the user is determined not to be a recruitment target, and the process proceeds to Step S9. At the time, the flag indicating that the user is a recruitment target in the user information table is turned OFF.

In Step S9, the target extracting unit 3014 determines whether or not the record of any other users exists in the user information table.

If it is determined that the record of any other users exists in the user information table in Step S9, the process returns to Step S5 and the record of the next user is extracted and performs the subsequent processing.

If it is determined that the record of any other users does not exist in the user information table in Step S9, the processing ends.

(Recruitment Processing)

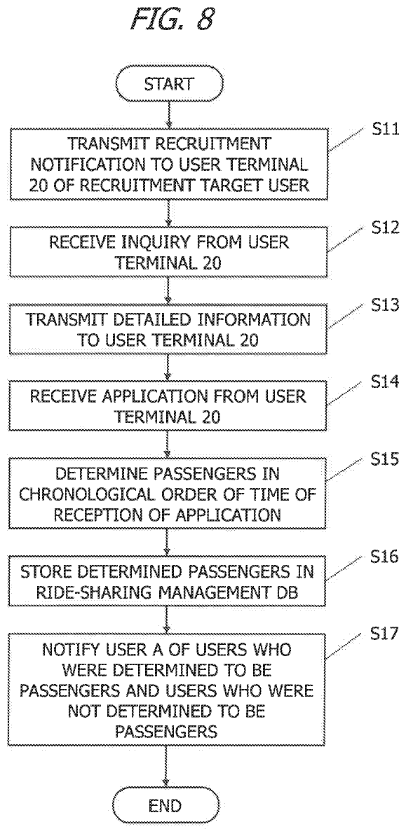

The details of recruitment processing performed by the control unit 301 of the server 30 will now be described with reference to the flow chart of FIG. 8.

In Step S11, the recruitment notification transmitter unit 3011 generates a recruitment notification from the record of the ride-sharing ID 2018100032 stored in the ride-sharing management DB. This recruitment notification is information notified to the user terminal 20 through a push notification. Regardless of whether or not the ride-share application is started up on the user terminal 20 or regardless of a request from the user terminal 20, it is transmitted from the server 30 to the user terminal 20 via the network N1, and is displayed on the input/output unit 205 in a popup display or other forms. When a recruitment notification is received at and displayed on the user terminal 20, vibrations or sounds may be generated at the same time. Since a push notification typically has a limited amount of transmittable information, a recruitment notification is used to simply notify the user that ride-sharing is under planning. For example, the recruitment notification “Depart in 20 minutes! Would you like to ride-share to the Kawagoe Station, departing from the Tokyo Metropolitan Government Office today at 16:00?” is generated. Subsequently, the recruitment notification transmitter unit 3011 acquires a terminal ID from the contact information 1 field of the user for whom the flag indicating that he/she is a recruitment target is ON in the user information table. Afterwards, the recruitment notification transmitter unit 3011 transmits a recruitment notification in the form of a push notification to the user terminal 20 of the user extracted as a recruitment target through the communication unit 302. A message included in a recruitment notification is not necessarily like this. Alternatively, selection can be made from multiple options or text can be entered by the user A through the input/output unit 105 of the user terminal 10.

In the user terminal 20 receiving a recruitment notification, the recruitment information processing unit 2012 forces the input/output unit 205 to display a message. Together with or separately from the message, an inquiry button that requests transmission of detailed information on the ride-sharing is displayed on the input/output unit 205. When a user interested in the ride-sharing that is recruiting users taps the inquiry button, the recruitment information processing unit 2012 requests the server 30 to transmit detailed information on the ride-sharing. Thus, a push notification can be said to be communication processing started by a sender. Examples of known communication procedure for achieving a push notification via the Internet include HTTP server push and Java (registered trademark) pushlet.

In Step S12, the detailed information transmitter unit 3012 receives an inquiry from the user terminal 20.

In Step S13, in response to the inquiry from the user terminal 20, the detailed information transmitter unit 3012 generates detailed information including the profile of the user who is the planner of the ride-sharing, the car model of the vehicle, the travel path from the departure point to the destination, and the cost, and transmits them to the user terminal 20. Transmission of the inquiry from the user terminal 20 to the server 30 and detailed information from the server 30 to the user terminal 20 may adopt an appropriate communication method according to the format of the detailed information.

In the user terminal 20 receiving detailed information, the recruitment information processing unit 2012 forces the input/output unit 205 to display it. The user viewing the detailed information determines whether to apply for the ride-sharing. Together with or separately from the detailed information displayed on the input/output unit 205, an apply to ride-sharing button is displayed. When a user taps the apply button, the recruitment information processing unit 2012 transmits information indicating that the user is applying for the ride-sharing to the server 30.

In Step S14, the matching management unit 3015 receives the application to the ride-sharing from the user terminal 20. The matching management unit 3015 stores the time at which the application from the user is received. The user who transmitted the application from the user terminal 20 is a carpool demander who demands carpooling related to the ride-sharing in response to a notification.

In Step S15, the matching management unit 3015 determines the users to be carpool passengers for ride-sharing in the chronological order of the time of reception of the application until the number of people to be recruited is filled up. Although carpool passengers are determined in the chronological order of the time of reception of the application here, an application deadline may be provided and matching may end when the application deadline passes regardless of whether the number of people to be recruited is filled up (the same applies to the other embodiments).

In Step S16, the matching management unit 3015 stores information on users who are determined to be carpool passengers for the ride-sharing, in the ride-sharing management database.

In Step S17, the matching management unit 3015 notifies the user who plans the ride-sharing and the users who are determined to be carpool passengers of the fact that users to ride-share have been determined, and the processing then ends. Among users who give the reply that they are applying for ride-sharing, users who are not determined to be carpool passengers for the ride-sharing are notified that recruitment has been finished for the ride-sharing.

Between the time when carpool passengers for the ride-sharing are determined and the time when the users actually get in, the current positions of the user terminals 20 of the users who are determined to be carpool passengers may be transmitted to the user terminal 10 of the user A at predetermined intervals directly or via the server 30. Hence, the user A can recognize the action of each user who is determined to be a carpool passenger until when he/she actually gets in.

As described above, according to this embodiment, only users who can carpool in short time because their current positions are near the departure point are recruited as carpool passengers for ride-sharing: hence, even if the occasion of ride-sharing suddenly arises for users, flexible matching can be achieved without taking time.

Although users to be recruitment targets are extracted based on the distance from the departure point registered by the user A in this embodiment (the same applies to the second embodiment), this is not necessarily the reference position serving as a reference for determining the distance. The server 30 may acquire the current position of the user terminal 10 (the apparatus of the planner) which can be used as a reference position. In the case where the server 30 performs matching in the state where the user A is in a vehicle used for ride-sharing, the current position of the user terminal 10 is also the current position of the vehicle. Hence, for the user A who is already in the vehicle, efficient matching between carpool passengers can be achieved by matching users near the vehicle first. In the case where the user A can pick up carpool passengers at points other than the departure point, the user A may designate that point and register it as a reference for determining a distance. Multiple points may be set as reference points for determining a distance.

In this embodiment, a recruitment notification is transmitted to the user terminal 20 by a push notification. Hence, a recruitment notification is displayed even on the user terminal 20 of a user who has not started up the ride-sharing application on it. A recruitment notification is quickly sent to a user extracted as a target in response to a request from a user who planned the ride-sharing, and immediately becomes visible to the user. For this reason, matching can be immediately done without missing the sudden occasion of ride-sharing, for example, the time when a user is already driving a vehicle to be used for ride-sharing, or when there is no time before the scheduled departure time.

(First Modification)

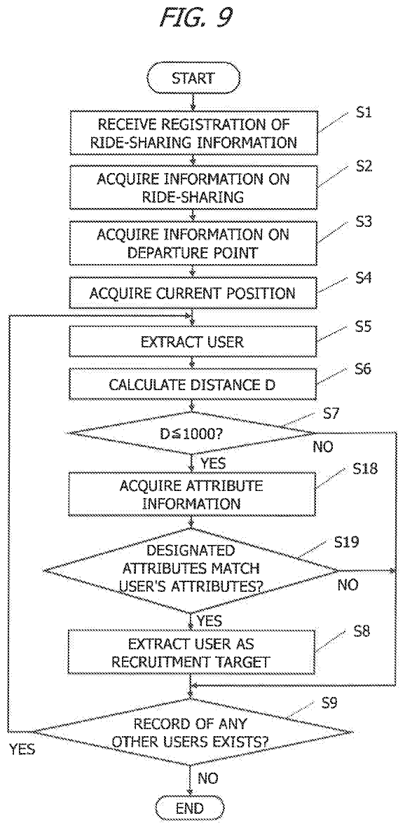

Recruitment target user extraction processing according to the first modification of the first embodiment will be explained with reference to FIG. 9. The apparatus configuration is the same as that in the first embodiment, and its detailed description will therefore be omitted.

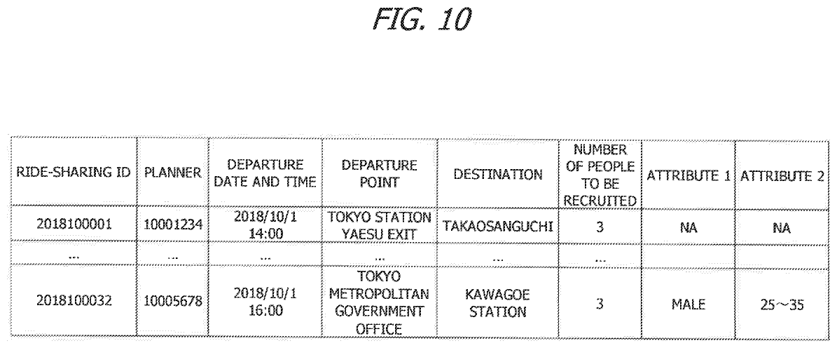

In the flowchart illustrated in FIG. 9, the same processing as in FIG. 7 is denoted by the same reference numeral as the corresponding processing and its description will be omitted. In this modification, the user A planning ride-sharing is requested to designate demanding attributes related to carpool passengers for the ride-sharing, and the server 30 adds the designated attributes to the criteria for extraction of recruitment targets and makes judgement. For this reason, as illustrated in FIG. 10, the ride-sharing management information table includes the attribute 1 field and the attribute 2 field storing designated attribute information related to carpool passengers for ride-sharing. Here, genders are stored as attributes 1, and ages are stored as attributes 2. The user A designates a male as a gender and 25-35 as an age.

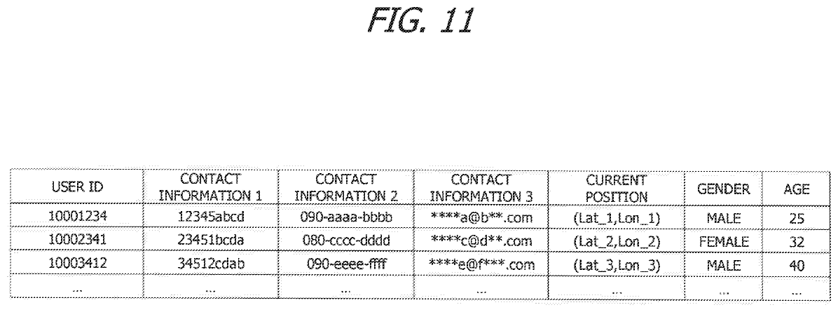

In this modification, when it is determined that D≤1000(m) in Step S7, the process proceeds to Step S18. In Step S18, the target extracting unit 3014 acquires attribute information on the users from the user information database 3031. A table configuration of user information stored in the user information database 3031 according to this modification is illustrated in FIG. 11. As illustrated in FIG. 11, the user information table includes user's attribute information such as an age field and a gender field.

In Step S19, the target extracting unit 3014 checks the attribute information on a user for whom it is determined that D≤1000 (m) against the attributes designated by the user A. Here, attribute information on the users with the user IDs 10001234, 10002341, and 10003412 is checked.

If it is determined that the attributes designated by the user A match the attribute information on the user for whom it is determined that D≤1000 (m) in Step S19, the process proceeds to Step S8. The gender and age of the user with the user ID 10001234 match the attribute information designated by the user A.

If it is determined that the attributes designated by the user A do not match the attribute information on the user for whom it is determined that D≤1000 (m) in Step S19, the process proceeds to Step S9. The gender of the user with the user ID 10002341 does not match the attribute information designated by the user A. The age of the user with the user ID 10003412 does not match the attribute information designated by the user A.

In Step S8, the target extracting unit 3014 extracts a user whose attribute information has been determined to match it in Step S19 as a recruitment target, and the process proceeds to Step S9. In the example illustrated in FIG. 11, the user ID 10001234 is extracted as a recruitment target.

Between the time when carpool passengers for the ride-sharing are determined and the time when the users actually get in, the current positions of the user terminals 20 of the users who are determined to be carpool passengers may be transmitted to the user terminal 10 of the user A at predetermined intervals directly or via the server 30. Hence, the user A can recognize the action of each user who is determined to be a carpool passenger until when he/she actually gets in.

As described above, according to this modification, recruiting carpool passengers for ride-sharing is limited to users whom current positions are near the departure point and who can carpool in short time: hence, even if the occasion of ride-sharing suddenly arises for users, flexible matching can be achieved without taking time. Further, more preferred matching reflecting a demand from a user who planned the ride-sharing can be achieved in relation to the attributes of carpool passengers for ride-sharing.

(Second Modification)

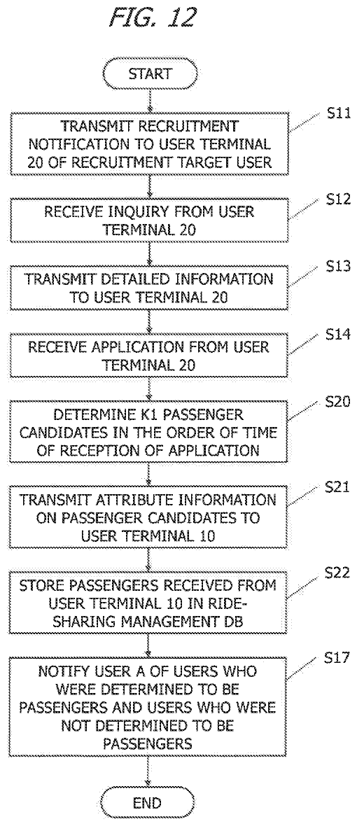

Recruitment processing according to the second modification of the first embodiment will be explained with reference to FIG. 12. The apparatus configuration is the same as that in the first embodiment, and its detailed description will therefore be omitted.

In the flow chart illustrated in FIG. 12, the same processing as in FIG. 8 is denoted by the same reference numeral as the corresponding processing and its description will be omitted. In this modification, among users who have applied for ride-sharing, users to be carpool passengers are selected by the user A.

To be specific, the process proceeds from Step S14 to Step S20. In Step S20, the matching management unit 3015 receives the application to the ride-sharing from the user terminal 20, a predetermined number (K1) of users are determined to be carpool passenger candidates in the chronological order of the time of reception of the application. Here, K1 is an appropriate integer which is greater than or equal to the number of people to be recruited.

In Step S21, attribute information on the predetermined number (K1) of users who are carpool passenger candidates from the user information database 3031, and is transmitted to the user terminal 10. In the user terminal 10, the matching processing unit 1013 causes attribute information on carpool passenger candidates to be displayed. The user terminal 10 displays a screen on which, among presented users, users to be carpool passengers are selected, and encourages the user A to make selection. When the user A determines carpool passengers, the matching processing unit 1013 transmits information on the users who are determined to be carpool passengers from the user terminal 10 to the server 30.

In Step S22, upon reception of the information on the users who are determined to be carpool passengers from the user terminal 10, the matching management unit 3015 stores information on the carpool passengers in the record of the ride-sharing in the ride-sharing management database 3032.

The process then proceeds to Step S17 in which the matching management unit 3015 notifies the users who are determined to be carpool passengers of this fact and terminates the processing. Among users who give the reply that they are applying for ride-sharing, users who are not determined to be carpool passengers for the ride-sharing are notified that recruitment has been finished for the ride-sharing.

Between the time when carpool passengers for the ride-sharing are determined and the time when the users actually get in, the current positions of the user terminals 20 of the users who are determined to be carpool passengers may be transmitted to the user terminal 10 of the user A at predetermined intervals directly or via the server 30. Hence, the user A can recognize the action of each user who is determined to be a carpool passenger until when he/she actually gets in.

As described above, according to this modification, recruiting carpool passengers for ride-sharing is limited to users whom current positions are near the departure point and who can carpool in short time: hence, even if the occasion of ride-sharing suddenly arises for users, flexible matching can be achieved without taking time. Further, more preferred matching reflecting a demand from a user who planned the ride-sharing can be achieved in relation to the attributes of carpool passengers for ride-sharing.

### Second Embodiment

The schematic configuration of the matching system 1 according to the second embodiment is the same as that in the first embodiment, and its detailed description will therefore be omitted.

The configurations of the user terminal 10 and the user terminal 20 according to the second embodiment are the same as those in the first embodiment, and their detailed description will therefore be omitted.

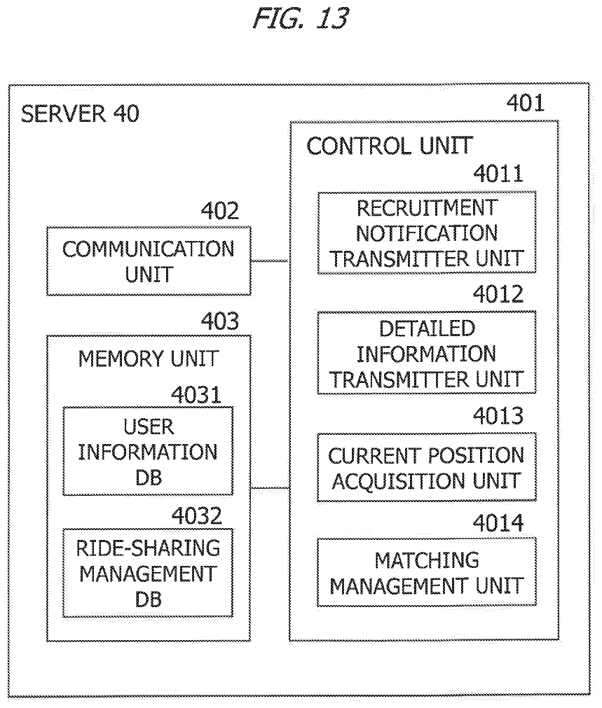

FIG. 13 illustrates the system configuration of a server 40 according to this embodiment. The hardware configuration of the server 40 is the same as that of the server 30, and its detailed description will therefore be omitted.

The server 40 includes a control unit 401, a communication unit 402, and a memory unit 403.

The communication unit 402 and the memory unit 403 are the same as the communication unit 302 and the memory unit 303, and their detailed description will therefore be omitted.

The control unit 401 is an arithmetic processing apparatus that is responsible for the control by the server 40. The control unit 401 can be implemented using an arithmetic processing apparatus such as a CPU.

The control unit 401 includes function modules of a recruitment notification transmitter unit 4011, a detailed information transmitter unit 4012, a current position acquisition unit 4013, and a matching management unit 4014. Each function module may be implemented by executing the program stored in the auxiliary storage apparatus through a CPU.

(Matching Processing)

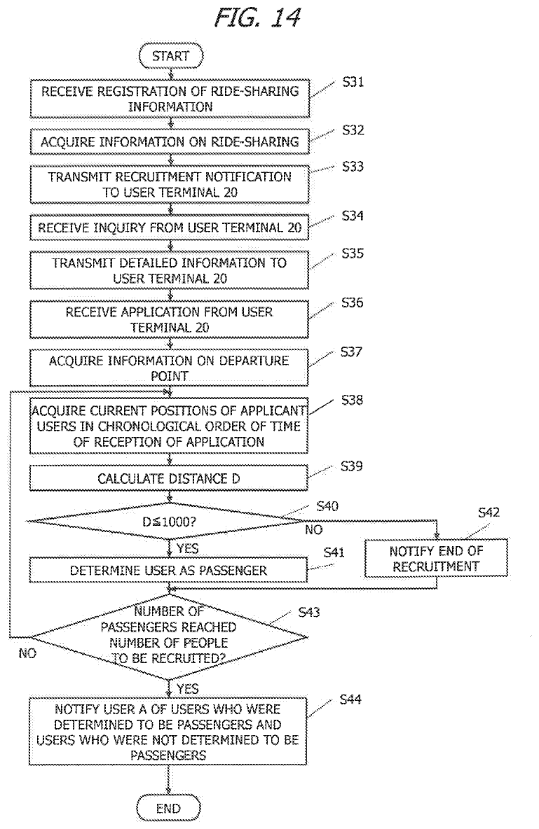

The details of matching processing performed by the control unit 401 of the server 40 as an information processing method will now be described with reference to the flow chart of FIG. 14.

First, in Step S31, registration of ride-sharing information is received from the user A who planned ride-sharing. The registration of ride-sharing information is the same as in Step S1, and its detailed description will therefore be omitted. When the user A registers ride-sharing information, the server 30 executes matching processing immediately or in response to a request from the user operating a button displayed on the input/output unit 105.

In Step S32, the matching management unit 4014 acquires information on ride-sharing, which is a matching target, from the ride-sharing management database 4032. Here, ride-sharing identified by the ride-sharing ID 2018100032 is a recruitment target.

In Step S33, the recruitment notification transmitter unit 4011 generates a recruitment notification from the record of the ride-sharing ID 2018100032 acquired in Step S32. The recruitment notification transmitter unit 4011 acquires a terminal ID stored in contact information 1, which is prepared for individual users, stored in the user information database 4031, and transmits a recruitment notification to the user terminal 20 identified by the terminal ID via the communication unit 402 by a push notification.

In Step S34, the detailed information transmitter unit 4012 receives an inquiry from the user terminal 20.

In Step S35, in response to the inquiry from the user terminal 20, the detailed information transmitter unit 4012 generates detailed information on ride-sharing, and transmits it to the user terminal 20. Transmission of the inquiry from the user terminal 20 to the server 40 and detailed information from the server 40 to the user terminal 20 may adopt an appropriate communication method according to the format of the detailed information.

In Step S36, the matching management unit 4014 receives the application to the ride-sharing from the user terminal 20. The matching management unit 3015 stores the time at which the application from the user is received. At this time, along with the application from the user terminal 20, the current position of the user terminal 20 acquired by the position acquisition unit 204 is transmitted from the current position transmitter unit 2011 to the server 40. Information on the current position of the user terminal 20 is received by the current position acquisition unit 4013 and is stored in the current position field of the user information table or the information stored therein is updated. The user who transmits the application from the user terminal 20 is a carpool demander who demands a carpool for the ride-sharing in response to a notification.

In Step S37, the matching management unit 4014 acquires information stored in the departure point field from the record related to target ride-sharing which has been acquired in Step S31. Here, for the ride-sharing ID 20181000032, “Tokyo Metropolitan Government Office” is stored in the departure point field. The server 40 has a table for converting the position on the map into a latitude and longitude, and information on the departure point is expressed by the latitude and longitude based on the table.

In Step S38, the matching management unit 4014 acquires current positions stored in the current position field of the user information table in the chronological order of the time of reception of the application from the user terminal 20.

In Step S39, the matching management unit 4014 calculates the distance D between the departure point acquired in Step S37 and the current position of the user terminal 20 acquired in Step S38.

In Step S40, the matching management unit 4014 determines whether or not D≤1000 (m). Although the threshold of the distance D is 1000 (m) here, this value may be set as appropriate considering the time to the departure time of the ride-sharing.

If it is determined that D≤1000 (m) in Step S40, the matching management unit 4014 determines the user to be a carpool passenger for ride-sharing in Step S41, and the process proceeds to Step S43.

If it is determined that D>1000 (m) in Step S40, the matching management unit 4014 notifies the user that recruitment has been finished for the ride-sharing in Step S42, and the process proceeds to Step S43.

In Step S43, the matching management unit 4014 determines whether or not the number of users who are determined to be carpool passengers for the ride-sharing in Step S41 has reached the number of people to be recruited.

If it is determined that the number of users who are determined to be carpool passengers for the ride-sharing has reached the number of people to be recruited in Step S43, the process proceeds to Step S44. In Step S44, the matching management unit 4014 notifies the user who planned the ride-sharing and the users who are determined to be carpool passengers of the fact that users to ride-share have been determined, and the processing then ends. Among users who give the reply that they are applying for ride-sharing, users who are not determined to be carpool passengers for the ride-sharing are notified that recruitment has been finished for the ride-sharing.

If the number of users who are determined to be carpool passengers for the ride-sharing has not reached the number of people to be recruited in Step S43, the process returns to Step S38, and users whose applications have been received earlier are then subject to the following processing.

Note that between the time when carpool passengers for the ride-sharing are determined and the time when the users actually get in, the current positions of the user terminals 20 of the users who are determined to be carpool passengers may be transmitted to the user terminal 10 of the user A at predetermined intervals directly or via the server 40. Hence, the user A can recognize the action of each user who is determined to be a carpool passenger until when he/she actually gets in.

As described above, according to this embodiment, among users who applied for ride-sharing, users who can carpool in short time because their current positions are near the departure point are determined to be carpool passengers: hence, even if the occasion of ride-sharing suddenly arises for users, flexible matching can be achieved without taking time.

In this embodiment, a recruitment notification is transmitted to the user terminal 20 by a push notification. Hence, a recruitment notification is displayed even on the user terminal 20 of a user who has not started up the ride-sharing application on it. A recruitment notification is quickly sent to a user in response to a request from a user who planned the ride-sharing, and immediately becomes visible to the user. For this reason, matching can be immediately done without missing the sudden occasion of ride-sharing, for example, the time when a user is already driving a vehicle to be used for ride-sharing, or when there is no time before the scheduled departure time.

(First Modification)

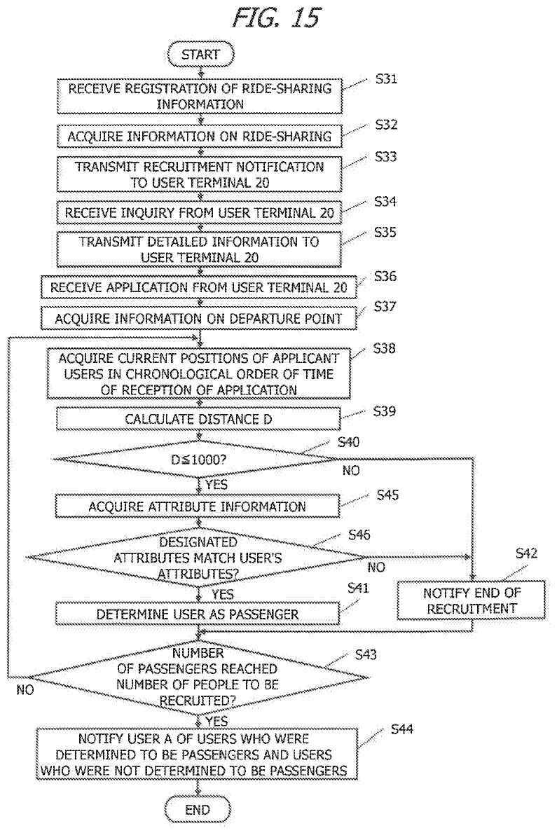

Matching processing according to the first modification of the second embodiment will be explained with reference to FIG. 15. The apparatus configuration is the same as that in the second embodiment, and its detailed description will therefore be omitted.

In the flow chart illustrated in FIG. 15, the same processing as in FIG. 14 is denoted by the same reference numeral as the corresponding processing and its description will be omitted. In this modification, the user A planning ride-sharing is required to designate demanding attributes related to carpool passengers for the ride-sharing, and the server 40 adds the designated attributes to the criteria for determining carpool passengers and makes judgement. For this reason, the ride-sharing management information table includes the attribute 1 field and the attribute 2 field storing designated attribute information related to carpool passengers for ride-sharing. The configuration of the ride-sharing management information table is the same as in FIG. 10.

In this modification, when it is determined that D≤1000(m) in Step S40, the process proceeds to Step S45. In Step S45, the matching management unit 4014 acquires attribute information on the users from the user information database 4031. A table configuration of user information stored in the user information database 4031 according to this modification is the same as in FIG. 11.

In Step S46, the matching management unit 4014 checks the attribute information on a user acquired in Step S45 against the attributes designated by the user A.

If it is determined in Step S46 that the attributes designated by the user A match the attribute information on the user acquired in Step S45, the matching management unit 4014 determines the user to be a carpool passenger in Step S41.

If it is determined in Step S46 that the attributes designated by the user A do not match the attribute information on the user acquired in Step S45, the process proceeds to Step S42.

The processing in Step S41 and Step S42 or later is the same as the processing according to the second embodiment.

As described above, according to this modification, among users who applied for ride-sharing, users who can carpool in short time because their current positions are near the departure point are determined to be carpool passengers: hence, even if the occasion of ride-sharing suddenly arises for users, flexible matching can be achieved without taking time. Further, more preferred matching reflecting a demand from a user who planned the ride-sharing can be achieved in relation to the attributes of carpool passengers for ride-sharing.

(Second Modification)

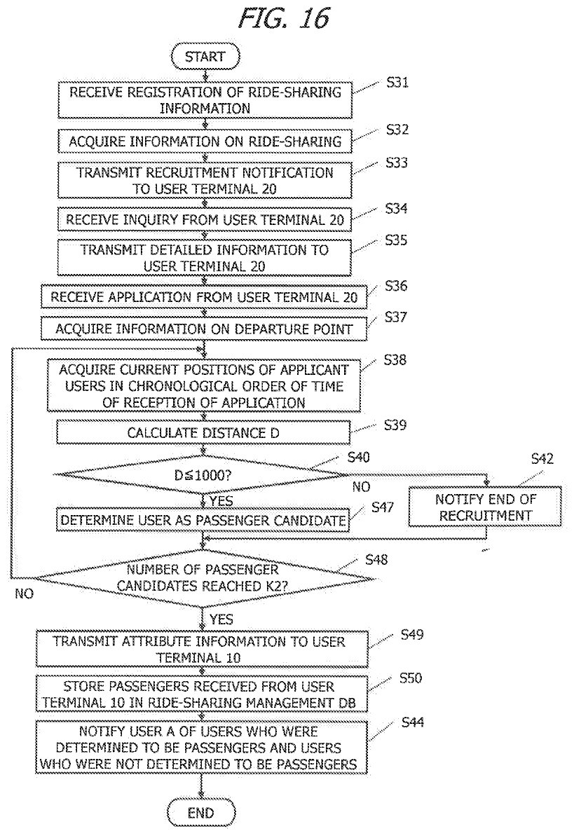

Matching processing according to the second modification of the second embodiment will be explained with reference to FIG. 16. The apparatus configuration is the same as that in the second embodiment, and its detailed description will therefore be omitted.

In the flow chart illustrated in FIG. 16, the same processing as in FIG. 14 is denoted by the same reference numeral as the corresponding processing and its description will be omitted. In this modification, among users who have applied for ride-sharing, the user A selects users to be carpool passengers.

To be specific, the process proceeds from Step S40 to Step S47 or Step S42. If it is determined that D≤1000 (m) in Step S40, the matching management unit 4014 determines the user to be a carpool passenger candidate for ride-sharing in Step S47, and the process proceeds to Step S48.

If it is determined that D>1000 (m) in Step S40, the matching management unit 4014 notifies the user that recruitment has been finished for the ride-sharing in Step S42, and the process proceeds to Step S48.

In Step S48, the matching management unit 4014 determines whether or not the number of users who are determined to be carpool passenger candidates for the ride-sharing in Step S47 has reached the predetermined number of people K2. Here, K2 is an appropriate integer which is greater than or equal to the number of people to be recruited.

If it is determined that the number of users who are determined to be carpool passenger candidates for the ride-sharing has reached K2 in Step S48, the process proceeds to Step S49. In Step S49, the matching management unit 4014 acquires attribute information on K2 users who are determined to be carpool passenger candidates from the user information database 4031 and transmits it to the user terminal 10. In the user terminal 10, the matching processing unit 1013 causes attribute information on K2 users who are determined to be carpool passenger candidates to be displayed. The user terminal 10 displays a screen on which, among presented users, users to be carpool passengers are selected, and encourages the user A to make selection. The matching processing unit 1013 transmits information on the users who are determined to be carpool passengers by the user A from the user terminal 10 to the server 40 through the wireless communication unit 103 and via the network N1.

In Step S50, upon reception of the information on the users who have been selected as carpool passengers from the user terminal 10, the matching management unit 4014 stores information on the carpool passengers in the record of the ride-sharing in the ride-sharing management database 4032.

In Step S44, the matching management unit 4014 notifies the users who are determined to be carpool passengers of this fact, and the processing then ends. Among users who give the reply that they are applying for ride-sharing, the users who are not determined to be carpool passengers for the ride-sharing the and users who are determined to be carpool passenger candidates but not selected as carpool passengers are notified that recruitment has been finished for the ride-sharing.

As described above, according to this modification, among users who applied for ride-sharing, users who can carpool in short time because their current positions are near the departure point are determined to be carpool passengers: hence, even if the occasion of ride-sharing suddenly arises for users, flexible matching can be achieved without taking time. Further, more preferred matching reflecting a demand from a user who planned the ride-sharing can be achieved in relation to the attributes of carpool passengers for ride-sharing.

### Third Embodiment

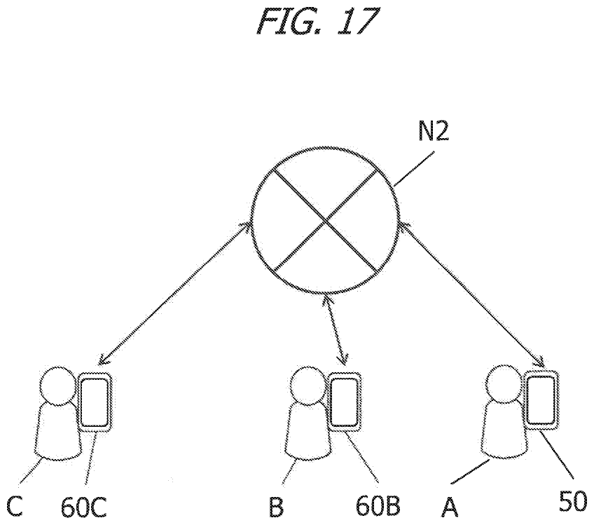

FIG. 17 is a diagram illustrating a schematic configuration of a matching system 2 (hereinafter referred to as “system 2”) according to this embodiment. In the example illustrated in FIG. 17, the system 2 includes a user terminal 50 owned by a user A, and user terminals 60B and 60C owned by users B and C, respectively. In the description below, when the user terminals 60B and 60C are collectively indicated, B and C for distinguishing between users are omitted. The user terminal 50 and the user terminals 60 are connected to each other via a network N2.

The network N2 is a wireless network according to or conforming to a predetermined wireless communication standard (Radio Access Technology (RAT)). Examples include wireless networks according to or conforming to 3G, Long Term Evolution (LTE), 5G, and other cellular communication standards, wireless LAN, Bluetooth (registered trademark), Bluetooth (registered trademark) Low Energy (BLE), Worldwide Interoperability for Microwave Access (WiMAX), and Cellular Vehicle-to-Everything (CV2X). Note that any wireless communication standard other than those described above may be used as long as it enables transmission and reception of needed information between the user terminal 50 and each user terminal 60.

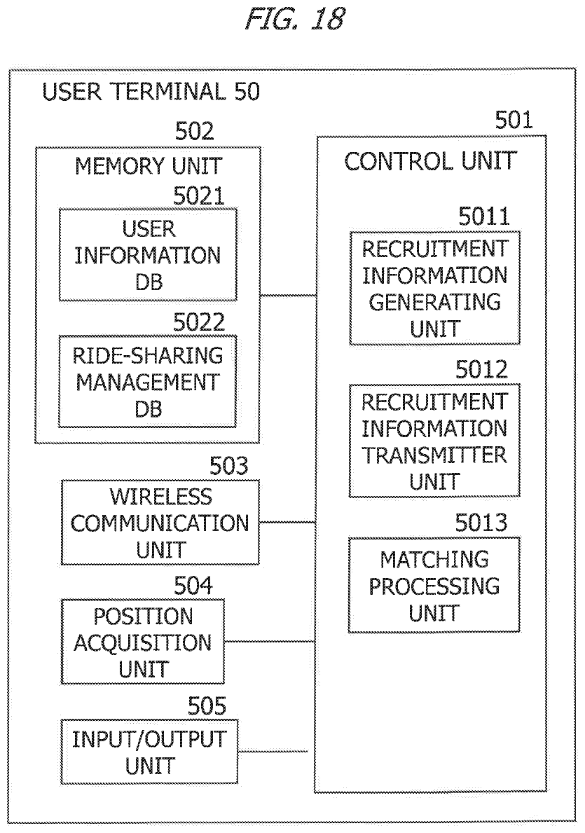

The configuration of the user terminal 50 will now be described. FIG. 18 is a diagram illustrating the system configuration of the user terminal 50.

The user terminal 50 is a terminal owned by the user A who plans ride-sharing. As in the first embodiment, the user A who plans ride-sharing is the user driving a vehicle used for ride-sharing.

The user terminal 50 is, for example, a smartphone, a cellular phone, a. tablet computer, a personal information terminal, a laptop computer, a wearable computer (such as a smartwatch), or other compact computers. The user terminal 50 includes a control unit 501, a memory unit 502, a wireless communication unit 503, a position acquisition unit 504, and an input/output unit 505.

The control unit 501 is an arithmetic processing apparatus that is responsible for the control by the user terminal 50. The control unit 501 can be implemented using an arithmetic processing apparatus such as a CPU.

The control unit 501 includes function modules of a recruitment information generating unit 5011, a recruitment information transmitter unit 5012, and a matching processing unit 5013. Each function module may be implemented by executing a program stored in the memory unit 502, which will be described later, through a CPU.

The recruitment information generating unit 5011 generates ride-sharing recruitment information used to notify that carpool passengers will be recruited for ride-sharing planned by the user A. Information input by the user A is also stored in the ride-sharing information DB5022 of the memory unit 502.

The recruitment information transmitter unit 5012 transmits ride-sharing recruitment information generated by the recruitment information generating unit 5011 to the user terminals 60 by controlling the wireless communication unit 503.

The matching processing unit 5013 receives a response to the ride-sharing recruitment information and determines carpool passengers for the ride-sharing.

The memory unit 502 includes a main memory apparatus and an auxiliary storage apparatus. The main memory apparatus and the auxiliary storage apparatus are the same as those in the memory unit 102, and their detailed description will therefore be omitted.

The memory unit 502 stores a user information database 5021 and a ride-sharing management database 5022.

The user information database 5021 is a database storing information on users who responded to the ride-sharing recruitment information.

The ride-sharing management database 5022 is a database storing information on ride-sharing that is planned by the user A.

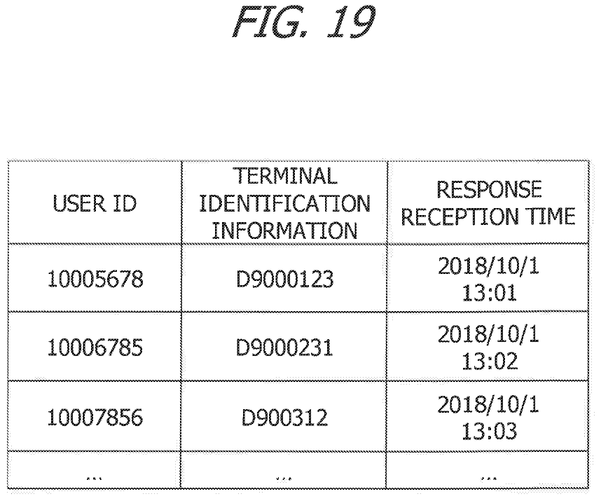

A table configuration of user information stored in the user information database 5021 will now be described with reference to FIG. 19.

The user information table includes a user ID field, a terminal identification information field, and a response reception time field.

In the user ID field, user IDs which are identification information for identifying users are stored.

In the terminal identification information field, for communication with a user terminal 60, information for identifying the user terminal is stored through the wireless communication unit 503. Terminal identification information is given to each user terminal according to the method of wireless communication between the user terminal 50 and each user terminal 60.

In the response reception time field, the times at which a response from each user terminal 60 is received is stored through the wireless communication unit 503.

A table configuration of ride-sharing management information stored in the ride-sharing management database 5022 will now be described.

The planner field stores identification information for identifying users who planned ride-sharing. Here, the name of the user A is stored.

The departure date and time field, the departure point field, the destination field, and the number of people to be recruited field are the same as in the respective fields of the ride-sharing management database 4032, and their detailed description will therefore be omitted.

The wireless communication unit 503 is a communication interface for connecting the user terminal 50 to the network N2. The communicable distance of the wireless communication unit 503 from the user terminal 50 is limited. Multiple wireless communication units may be provided for supporting different wireless communication methods. In addition, the wireless communication unit 503 may change the coverage by changing the power of radio waves to be transmitted.

In this embodiment, an example method of limiting the communicable distance of the wireless communication unit 503 from the user terminal 50 is as described below. For example, the wireless communication unit 503 includes a communication unit using an ad hoc communication method, for example, Bluetooth Low Energy (BLE), Bluetooth, ZigBee (registered trademark), or a wireless LAN, and the control unit 501 implements push notification processing, thereby achieving communication with limited communicable distance. In the case where the wireless communication unit 503 includes a wireless LAN interface, it can directly communicate with a wireless LAN adapter provided to the user terminal 60, using the ad hoc mode. The communicable distance is reported to be, for example, several meters to several tens of meters by BLE, 10 m to 100 m by Bluetooth, up to 400 m by Bluetooth 5, 10 m to 100 m by ZigBee, and 100 m to 300 m by a wireless LAN. In the case where the wireless communication unit 503 uses BLE, Bluetooth, ZigBee, a wireless LAN, or the like, the user terminal 60 used by a user receiving ride-sharing recruitment information is assumed to also have an interface of the supported communication method. The position acquisition unit 504 acquires the current position of the user terminal 50. The position acquisition unit 604 has the same configuration as the position acquisition unit 104, and its detailed description will therefore be omitted.

The input/output unit 505 presents information to the user in response to input operation made by the user. The input/output unit 505 has the same configuration as the input/output unit 105, and its detailed description will therefore be omitted.

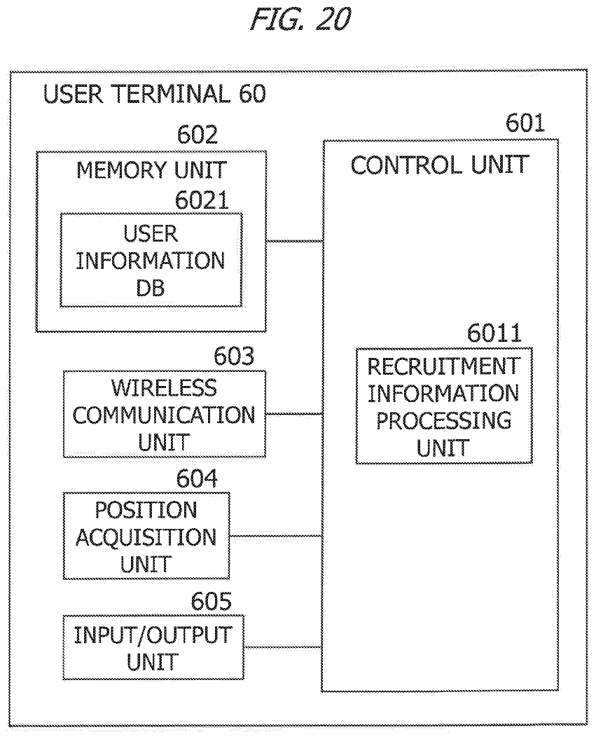

The configuration of the user terminal 60 will now be described. FIG. 20 is a diagram illustrating the system configuration of the user terminal 60.

The user terminal 60 is a terminal owned by a user who receives ride-sharing recruitment information.

The user terminal 60 is, for example, a smartphone, a cellular phone, a tablet computer, a personal information terminal, a laptop computer, a wearable computer (such as a smartwatch), or other compact computers. The user terminal 60 includes a control unit 601, a memory unit 602, a wireless communication unit 603, a position acquisition unit 604, and an input/output unit 605.

The control unit 601 is an arithmetic processing apparatus that is responsible for the control by the user terminal 60. The control unit 601 can be implemented using an arithmetic processing apparatus such as a CPU.

The control unit 601 includes a function module of a recruitment information processing unit 6011. The function module may be implemented by executing a program stored in the memory unit 602, which will be described later, through a CPU.

The recruitment information processing unit 6011 receives ride-sharing recruitment information transmitted from the user terminal 50 via the wireless communication unit 603, and presents the ride-sharing recruitment information to the user through the input/output unit 605. The recruitment information processing unit 6011 also receives an application to ride-sharing from the user, and transmits information including the application to the ride-sharing to the user terminal 50. The recruitment information processing unit 6011 also receives information of whether or not the user is determined to be a carpool passenger for the ride-sharing, from the user terminal 50.

The memory unit 602 includes a main memory apparatus and an auxiliary storage apparatus. The main memory apparatus and the auxiliary storage apparatus are the same as those in the memory unit 102, and their detailed description will therefore be omitted.

The memory unit 602 stores user information 6021 including information on each user who owns the user terminal 60 and the user terminal.

The wireless communication unit 603 is a communication interface for connecting each user terminal 60 to the network N2.

The position acquisition unit 604 acquires the current position of the user terminal 60. The position acquisition unit 604 has the same configuration as the position acquisition unit 104, and its detailed description will therefore be omitted.

The input/output unit 605 presents information to the user in response to input operation made by the user. The input/output unit 605 has the same configuration as the input/output unit 105, and its detailed description will therefore be omitted.

(Matching Processing)

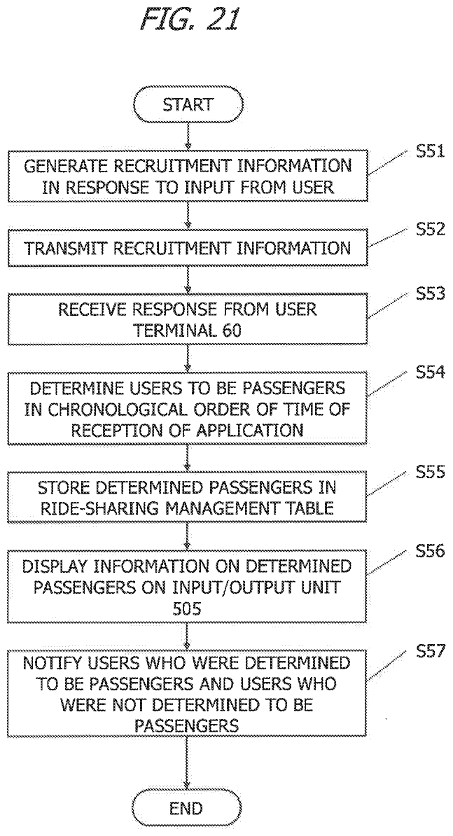

Matching processing as an information processing method according to this embodiment will now be explained with reference to the flowchart of FIG. 21.

In Step S51, the user A starts up a matching application on the user terminal 50, and enters a departure point, a destination, a scheduled departure date and time, a number of people to be recruited, and the like through the input/output unit. The recruitment information generating unit 5011 generates ride-sharing recruitment information used to recruit carpool passengers for ride-sharing planned by the user A, based on the input information.

In Step S52, in response to a response from the user A, ride-sharing recruitment information is transmitted through the wireless communication unit 503. For example, with the matching application in the user terminal 50, input items, such as a departure point, related to ride-sharing are checked, a transmit button is displayed, and ride-sharing recruitment information is transmitted upon detection of touch to the transmit button by the user A. In this embodiment, in transmission of information including ride-sharing recruitment information from the wireless communication unit 503, the transmission destination is not specified. Information including ride-sharing recruitment information includes information through which the user terminal receiving it specifies it as information including ride-sharing recruitment information directed at users of the system 2. In addition, in this embodiment, the communicable distance of the wireless communication unit 503 as a communication unit from the user terminal 50 is limited. For this reason, only the user terminals 60 that are present in the coverage can receive information including ride-sharing recruitment information transmitted from the user terminal 50. In other words, in this embodiment, the reference position is the position of the user terminal 50, and the condition related to a distance from a reference position is that the user terminals 60 are in the communication media's coverage from the user terminal 50. In the case where the user A is in a vehicle used for ride-sharing or the user terminal 50 is an in-car terminal, the reference position is the position of the vehicle used for ride-sharing. Alternatively, the user A may designate the position of his/her user terminal 50 as a reference position so that matching processing according to this embodiment may be executed.

Upon reception of information including ride-sharing recruitment information, the user terminal 60 starts up an application, and presents ride-sharing recruitment information to the user through the input/output unit 605. A user who intends to apply for ride-sharing targeted by ride-sharing recruitment information inputs his/her intention to apply for it through the input/output unit 605. Upon reception of the input from the user, the application of the user terminal 60 transmits a response to the user terminal 50 specified by the terminal identification information included in the previously received information. Here, the response to the user terminal 50 includes user information stored in the memory unit 602.

In Step S53, the matching processing unit 5013 receives a response from the user terminal 60 that has received information including ride-sharing recruitment information transmitted from the user terminal 50. When receiving a response from the user terminal 60, the matching processing unit 5013 stores the time at which a response from each user terminal 60 is received. The user who transmitted the response indicating his/her intention to apply for it from the user terminal 60 is a carpool demander who demands carpooling for the ride-sharing in response to the notification.

In Step S54, the matching processing unit 5013 determines users to be carpool passengers for ride-sharing in the chronological order of the time of reception of the application until the number of people to be recruited is filled up.

In Step S55, the matching processing unit 5013 stores information on users who are determined to be carpool passengers for the ride-sharing, in the ride-sharing management database 5022.

In Step S56, the matching processing unit 5013 forces the input/output unit 505 of the user terminal 50 to display information on the users who are determined to be carpool passengers for the ride-sharing.

In Step S57, the matching processing unit 5013 notifies the users who are determined to be carpool passengers for the ride-sharing of this fact through the wireless communication unit 503, and notifies the users who have applied for the ride-sharing but not determined to be carpool passengers of the fact that recruitment has been finished.

Note that between the time when carpool passengers for the ride-sharing are determined and the time when the users actually get in, the current positions of the user terminals 60 of the users who are determined to be carpool passengers may be transmitted to the user terminal 50 of the user A at predetermined intervals. Hence, the user A can recognize the action of each user who is determined to be a carpool passenger until when he/she actually gets in.

As described above, according to this embodiment, recruiting carpool passengers for ride-sharing is limited to users whom current positions are near the departure point and who can carpool in short time: hence, even if the occasion of ride-sharing suddenly arises for users, flexible matching can be achieved without taking time.

Although information on a user is transmitted from the user terminal 60 in this embodiment, the response may include only a user ID, and the user terminal 50 receiving it may make an inquiry at a server that manages information on users including attribute information. In addition, matched ride-sharing information may be transmitted to and managed by a server that assists ride-sharing. Further, terminal identification information on the user terminals 60 may be acquired from the server that assists ride-sharing, ride-sharing recruitment information may be transmitted to each user terminal, and at the time of transmission, responses from the user terminals 60 present in the coverage of the wireless communication unit 503 may be received.

(First Modification)

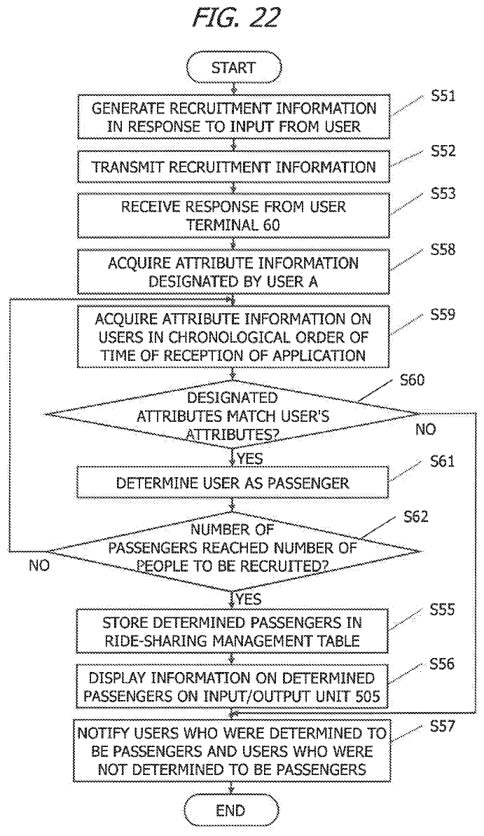

Processing according to the first modification of the third embodiment will be explained with reference to FIG. 22. The apparatus configuration is the same as that in the third embodiment, and its detailed description will therefore be omitted.

In the flow chart of FIG. 22, the same processing as in FIG. 21 is denoted by the same reference numeral as the corresponding processing and its description will be omitted. In this modification, the user A inputting information on ride-sharing is required to designate demanding attributes related to carpool passengers for the ride-sharing which are then checked against the attribute information included in the responses from the users, thereby determining carpool passengers.

In this modification, in Step S53, upon reception of a response from the user terminal 60, attribute information is also stored in the user information database 5021.

After receiving the response from the user terminal 60 in Step S53, the matching processing unit 5013 acquires attribute information designated by the user A in Step S58.

In Step S59, the matching processing unit 5013 acquires attribute information of users in the chronological order of the time of reception of the application.

In Step S60, the matching processing unit 5013 checks the attribute information on a user acquired in Step S59 against the attribute information designated by the user A.

If it is determined that the attribute information designated by the user A matches the attribute information on the user in Step S60, the process proceeds to Step S61 in which the user is determined to be a carpool passenger.

If it is determined that the attribute information designated by the user A does not match the attribute information on the user in Step S60, the process proceeds to Step S57.

In Step S62, the matching processing unit 5013 determines whether or not the number of users who are determined to be carpool passengers has reached the number of people to be recruited.

If it is determined that the number of users who are determined to be carpool passengers has reached the number of people to be recruited in Step S62, the process proceeds to Step S55.

If it is determined that the number of users who are determined to be carpool passengers has not reached the number of people to be recruited in Step S62, the process returns to Step S59.

As described above, according to this modification, recruiting carpool passengers for ride-sharing is limited to users whom current positions are near the departure point and who can carpool in short time: hence, even if the occasion of ride-sharing suddenly arises for users, flexible matching can be achieved without taking time. Further, more preferred matching reflecting a demand from a user who planned the ride-sharing can be achieved in relation to the attributes of carpool passengers for ride-sharing.

(Second Modification)

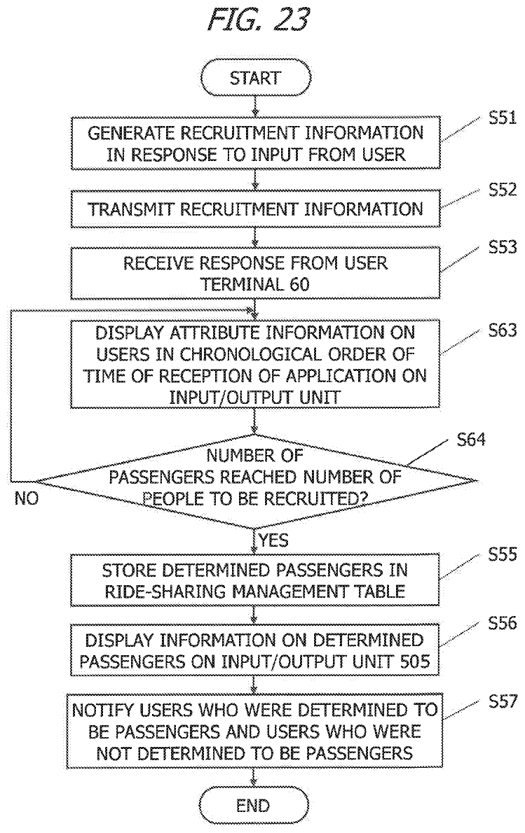

Processing according to the second modification of the third embodiment will be explained with reference to FIG. 23. The apparatus configuration is the same as that in the third embodiment, and its detailed description will therefore be omitted.

In the flow chart illustrated in FIG. 23, the same processing as in FIG. 21 is denoted by the same reference numeral as the corresponding processing and its description will be omitted. In this modification, a user responding in relation to ride-sharing recruitment information is required to transmit attribute information, and the user A is required to select users as carpool passengers.

In this modification, after reception of a response from a user terminal 60 in Step S53, information of users for which responses have been received, including attribute information, is displayed on the input/output unit 505 in the chronological order of the time of reception of the application in Step S63. At this time, selection of users to be determined to be carpool passengers is received from the user A through the input/output unit 505.

In Step S64, the matching processing unit 5013 determines whether or not the number of users who are determined to be carpool passengers by the user A has reached the number of people to be recruited.

If the number of users who are determined to be carpool passengers by the user A has reached the number of people to be recruited in Step S64, the determined carpool passengers are stored in the ride-sharing management table in Step S55, and the process proceeds to Step S56.

If the number of users who are determined to be carpool passengers by the user A has not reached the number of people to be recruited in Step S64, the process returns to Step S63.

In Step S56, information on the users who are determined to be carpool passengers is displayed on the input/output unit 505.

In Step S57, the matching processing unit 5013 notifies the users who are determined to be carpool passengers of this fact, and notifies the users who are not determined to be carpool passengers of the fact that recruitment has finished.

As described above, according to this modification, recruiting carpool passengers for ride-sharing is limited to users whom current positions are near the departure point and who can carpool in short time: hence, even if the occasion of ride-sharing suddenly arises for users, flexible matching can be achieved without taking time. Further, more preferred matching reflecting a demand from a user who planned the ride-sharing can be achieved in relation to the attributes of carpool passengers for ride-sharing.

(Modification)

The above-described embodiment is merely illustrative and appropriate modification can be made without departing from the scope of the present disclosure.

The processing and means described in this disclosure can be freely combined unless technical inconsistencies arise.

In addition, processing supposed to be done with one apparatus according to the above description may be executed with multiple apparatuses. For example, the servers 30 and 40 may be in-car terminals mounted in vehicles used for ride-sharing. Further, the functions of the servers 30 and 40 may be implemented by a computer apparatus and the in-car terminal. For example, the user terminals 10 and 50 may be terminals mounted in vehicles used for ride-sharing. The vehicles may be vehicles manually driven by a driver or vehicles that autonomously drive. The in-car terminals may be navigation apparatuses or apparatuses connected to a navigation apparatus, or computers for performing autonomous driving.

Further, processing supposed to be done with different apparatuses according to the above description may be executed with one device. In a computer system, the type of hardware configuration (server configuration) used to implement each function can be flexibly changed.

The present disclosure can be implemented when a computer program having the functions that have been described in the above embodiments is supplied to a computer, and one or more processors in the computer read and execute the program. Such a computer program may be provided to the computer via a non-transitory computer-readable storage medium that can be connected to the computer's system bus or via a network. Examples of non-transitory computer-readable storage medium include any type of disks such as magnetic disks (such as floppy (registered trademark) disks and hard disk drives (HDDs)), and optical disks (such as CD-ROMs, DVD disks, and Blu-ray disks), read only memories (ROMs), random access memories (RAMs), EPROMs, EEPROMs, magnetic cards, flash memories, optical cards, and any type of media suitable for storing electronic instructions.

What is claimed is:

1. An information processing apparatus comprising a processor configured to:
transmit, through a communicator, a notification that a carpool passenger is recruited, according to a request from a planner who planned ride-sharing, and
acquire information on a carpool demander who demands carpooling for the ride-sharing in response to the notification, the carpool demander satisfying a condition related to a distance from a reference position.

2. The information processing apparatus according to claim 1, wherein the processor is configured to transmit the notification that the carpool passenger is recruited by a push notification through the communicator.

3. The information processing apparatus according to claim 1, wherein the communicator is configured to transmit the notification through a first communicator which has a limited communicable distance from the reference position, according to the condition.

4. The information processing apparatus according to claim 1, wherein the processor is configured to acquire information related to a position of the carpool demander, from the carpool demander responding to the notification through the communicator.

5. The information processing apparatus according to claim 1, wherein the processor is configured to:
acquire information related to positions of notification demanders who demand reception of a notification that a carpool passenger is recruited, through the communicator,
extract at least one of the notification demanders satisfying the condition, from the information related to the positions of the notification demanders, and transmit the notification according to a request from the planner to the extracted notification demander, through the communicator.

6. The information processing apparatus according to claim 1, wherein the processor is configured to acquire attribute information on the carpool demander who responded, and determine the carpool passenger according to the attribute information.

7. The information processing apparatus according to claim 1, wherein the processor is configured to receive selection of the planner made in response to the response, and determine the carpool passenger.

8. The information processing apparatus according to claim 1, wherein the reference position is a position of a vehicle used for the ride-sharing.

9. The information processing apparatus according to claim 1, wherein the reference position is a position of an apparatus of the planner.

10. The information processing apparatus according to claim 1, wherein the reference position is a position designated by the planner.

11. An information processing method comprising:
transmitting, through a communicator, a notification that a carpool passenger is recruited, according to a request from a planner who planned ride-sharing; and
acquiring information on a carpool demander who demands carpooling for the ride-sharing in response to the notification, the carpool demander satisfying a condition related to a distance from a reference position.

12. A non-transitory computer-readable medium recorded with a program causing a computer to execute:
transmitting, through a communicator, a notification that a carpool passenger is recruited, according to a request from a planner who planned ride-sharing; and
acquiring information on a carpool demander who demands carpooling for the ride-sharing in response to the notification, the carpool demander satisfying a condition related to a distance from a reference position,
